(19) United States
(12) Patent Application Publication
(10) Pub. No.: US 2013/0166463 A1
(43) Pub. Date: Jun. 27, 2013

(54) Process of Verifying the Factual Significance of Electronic Documents

(71) Applicant: Vladimir SAMOKHVALOV, Saint Petersburg (RU)

(72) Inventor: Vladimir SAMOKHVALOV, Saint Petersburg (RU)

(21) Appl. No.: 13/719,889

(22) Filed: Dec. 19, 2012

Related U.S. Application Data
(60) Provisional application No. 61/578,343, filed on Dec. 21, 2011.

(51) Int. Cl. G06Q 99/00

(52) U.S. Cl. CPC G06Q 99/00
USPC 705/317

(57) ABSTRACT

A method of verifying the factual significance of electronic documents includes an online application where an original electronic document can be submitted through a first subscriber account. An electronic voucher with protective codes and a unique registration number are generated for the submitted original electronic document. The electronic voucher provides supplemental data regarding the original electronic document. Then the electronic voucher and the protective codes are stored in multiple preferred servers where the multiple preferred servers are selected through a server selection process. A second subscriber, who wishes to check the authenticity of a copy of the original electronic document, can submit the copy with the unique registration number. The application software then generates control codes for the copy where the control codes are compared with the protective codes for the authenticity. The result is displayed to the second subscriber through a test result report.

The current application claims a priority to the U.S. Provisional Patent application Ser. No. 61/578,343 filed on Dec. 21, 2011.

### FIELD OF THE INVENTION

The present invention relates generally to a process of verifying the factual significance of electronic documents (e-documents) in the electronic communications system. The present invention provides a process to certify documents that are legally valid.

### BACKGROUND OF THE INVENTION

The current market lacks effective legal mechanisms to confirm the conditions of creating an electronic document and its invariability during storage. If a user presents an electronic document stored in his or her personal archive, the document may be disputed, on the basis that the user lacks proof certifying important features of the documents. For example, the user cannot prove on what date he or she created the document. Similarly, it is equally futile for the user to store the document with a party that provides a storage function. This form of confirmation is not legally valid because a third-party may make claims, such as, but not limited to: (1) that a technical failure occurred damaging the challenged features of the document while in possession of the person storing it; (2) that the third-party colludes with the user to alter the challenge features of the document; and (3) the storing party cannot produce any conclusive evidence of the authenticity of the document.

It is therefore an object of the present invention to enable the conditions of creating of an electronic document and its invariability during storage to be confirmed legally through an independent third party verification procedure. The present invention offers the traditional practice of legally confirming facts and events with the help of witnesses within the electronic environment. In an effort to provide additional clarity, it is essential to compare the problem with long-term document storage to those associated with electronic digital signature, i.e., the present electronic digital signature method is inconvenient and does little to nothing to resolve the problem of long-term document storage. The present invention is able to eliminate the inconvenience and the problem of long-term document storage.

### BRIEF DESCRIPTION OF THE DRAWINGS

FIG. 1 is a flow-chart illustrating the network diagram of the present invention from a perspective view of a first subscriber account.

FIG. 2 is a flow-chart illustrating the network diagram of the present invention from a perspective view of a second subscriber interface, where a positive test result report is the outcome.

FIG. 3 is a flow-chart illustrating the network diagram of the present invention from a perspective view of the second subscriber interface, where a negative test result report is the outcome.

FIG. 4 is a block-diagram illustrating the overall process of the present invention.

FIG. 5 is a block-diagram illustrating a random selection process.

FIG. 6 is a block-diagram illustrating a first subscriber account selection process.

FIG. 7 is a block-diagram illustrating at least one dispatch center selection process.

FIG. 8 is a block-diagram illustrating a record of facts selection process.

### DETAIL DESCRIPTIONS OF THE INVENTION

All illustrations of the drawings are for the purpose of describing selected versions of the present invention and are not intended to limit the scope of the present invention.

The present invention provides an online application that verifies the factual significance of an original electronic document in the electronic communication system other than the electronic signature. The present invention enables the conditions of creating of the original electronic document and its invariability during storage to be legally confirmed through an independent third party verification procedure. The present invention provides the independent third party verification procedure so that the traditional legal practice of legally confirming facts and events with the help of witnesses can be implemented to the electronic communication systems.

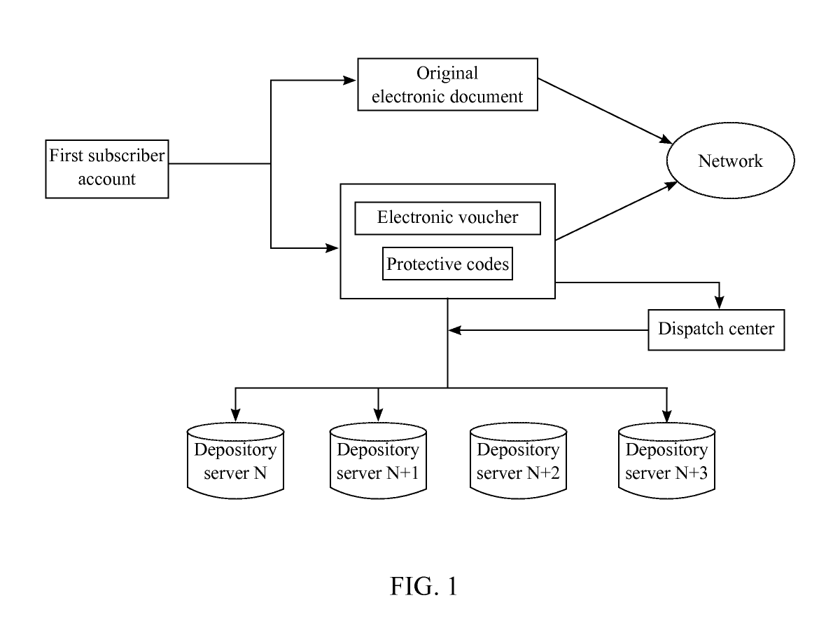

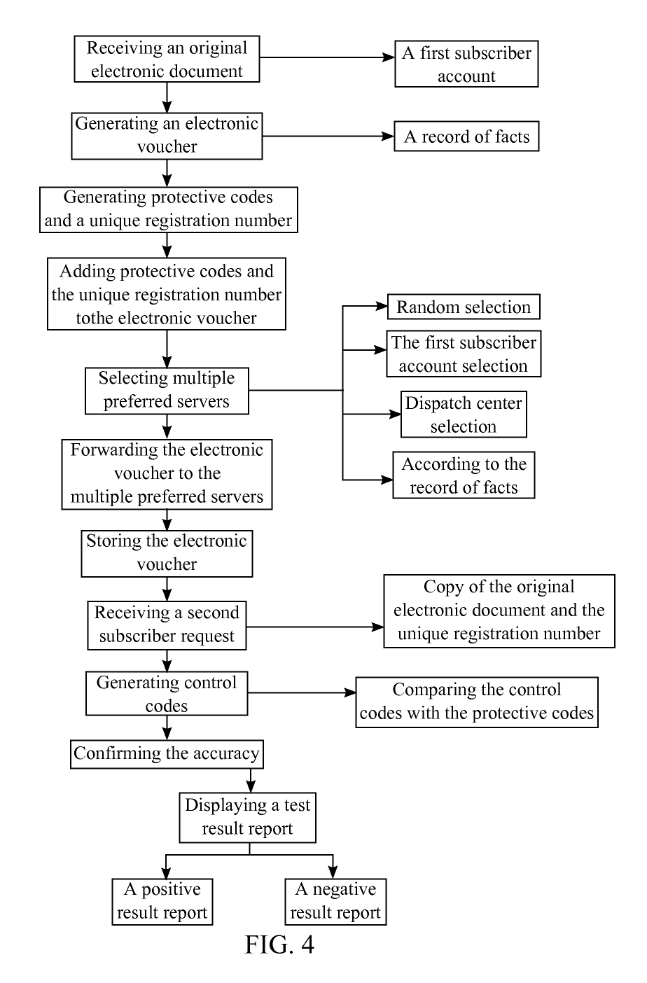

In reference to FIG. 1 and FIG. 4, a first subscriber account of the present invention is able to create an electronic voucher, special metadata supplementary document, for the original electronic document. The first subscriber account can create the original electronic document through a computing device, such as a personal computer, a laptop, a smartphone, a camcorder, a scanner, or any other related electronic devices. Once the original electronic document is created by the first subscriber account and submitted to the present invention, the present invention initiates the process by generating the electronic voucher for the original electronic document. The first subscriber account needs to make sure that the final release version of the original electronic document is used during the process of creating the electronic voucher so that the generated electronic voucher is completely accurate. The electronic voucher keeps a record of facts, which validate the conditions of the creating of the original electronic document. The record of facts represents factual verifications to the electronic voucher in a way that supports non-repudiation. In the preferred embodiment of the present invention, the electronic voucher includes the record of facts where the record of facts comprises a document location, a document time, a document date, a document format, a created electronic device, a subject matter, a document status, document content, and subscriber information. As an additional feature, additional storage may be offered to the first subscriber account so that the first subscriber account can store the original electronic document in a separate database.

The document location identifies where the original electronic document is created within the computing device and records the document location into the electronic voucher. The document location can be identified from the global positioning system, a mobile phone number, an IP-address of the internet service provider, or any other related sources. The document time records the specific creation time of the original electronic document in the electronic voucher. The document date records the specific creation date of the original electronic document in the electronic voucher. The document format records the final document format of the original electronic document in the electronic voucher, and the final document format can be a portable document format (PDF), a word file, a text file, or any other type of format files where the final format is readable to the humans. The created electronic device individually identifies the computer device that the original electronic document is created and records in the electronic voucher. The original electronic document's title is recorded in the subject matter of the electronic voucher, and the original electronic document's description is recorded in the document content of the electronic voucher. The first subscriber account can optionally provide personal information, such as name and phone numbers, where the personal information is recorded in the subscriber information of the electronic voucher. The document status can be determined by the first subscriber account where the document status describes the task to be performed on the original electronic document.

After the electronic voucher is generated, protective codes are generated to the original electronic document where the protective codes validate the authenticity of the original electronic document. Then the protective codes are added to the electronic voucher. The protective codes eliminate the possibility of altering the electronic voucher while the electronic voucher is stored. The protective codes use cryptographic hash function algorithms, such as, but not limited to, MD5, SHA-1, RIPEMD-160, SHA-3, so that the electronic voucher can't be accidently or intentionally altered by anyone during the storage. The electronic voucher may also include other related information where the first subscriber account can upload any other desired information, such as, but not limited to personal notes, reminders, important facts, with reference to the original electronic document.

The preferred embodiment of the present invention is also provided with a plurality of depository servers. Each of the plurality of depository servers enables the first subscriber account to register for the present invention, transfer electronic voucher in between the plurality of depository servers, subscription fees to be received, and server fees to be paid. Once the electronic voucher is generated and the protective codes are added, the present invention replicates the electronic voucher. The present invention organizes the electronic voucher so that the electronic voucher can be forwarded and stored within multiple preferred servers, where the multiple preferred servers are chosen from the plurality of depository servers by executing a server selection process. The server selection process can be executed randomly, according to the first subscriber account, according to dispatch center requests, and according to the record of facts.

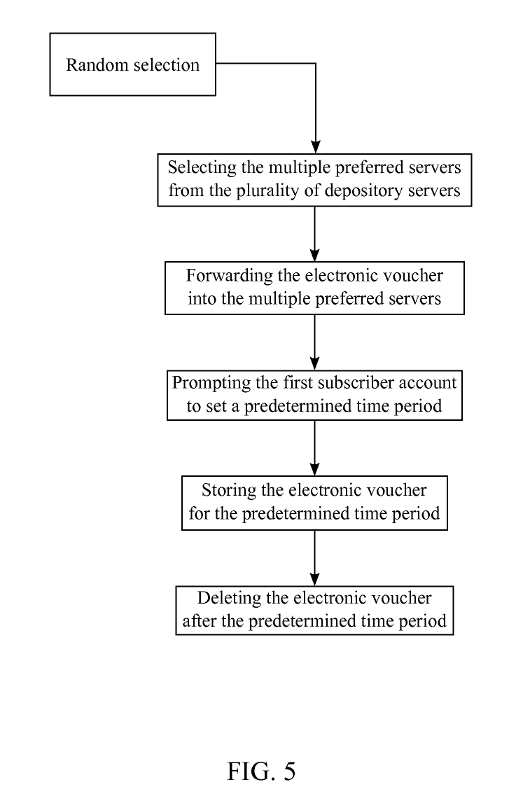

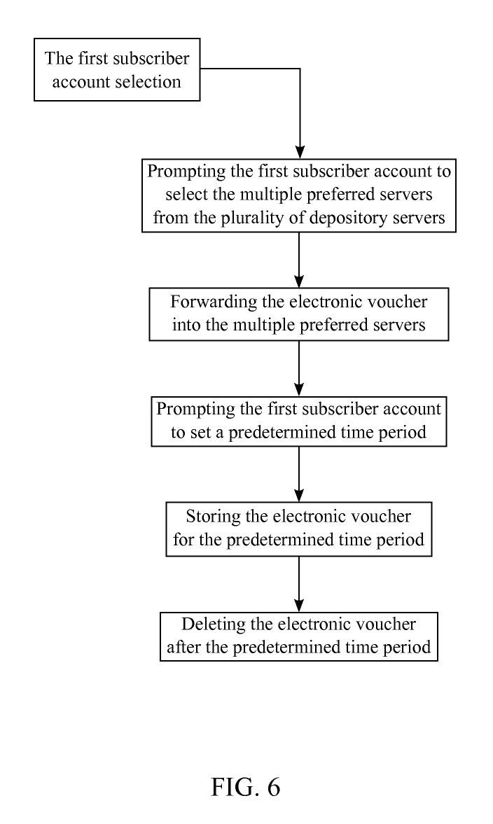

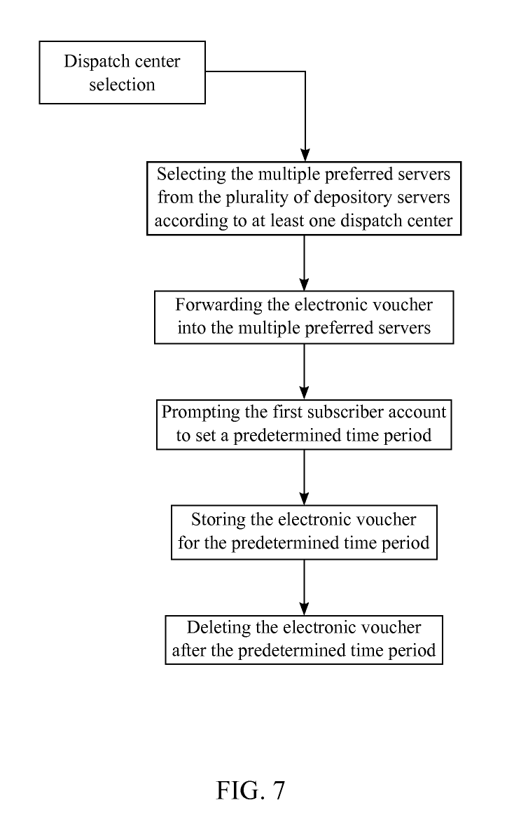

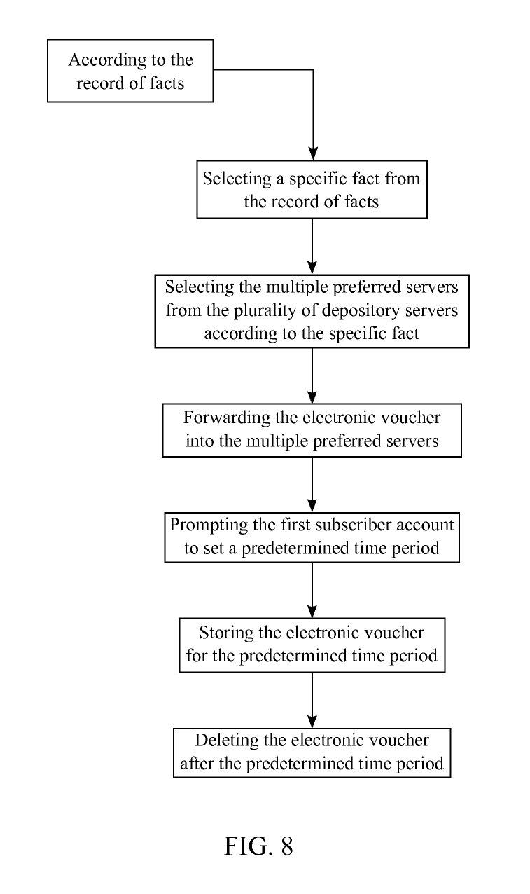

In reference to FIG. 5, FIG. 6, FIG. 7, and FIG. 8, when the multiple preferred servers randomly selected by the present invention, the electronic voucher is forwarded to the multiple preferred servers, the stored locations of the electronic voucher are concealed away from all of the subscribers of the present invention. When the multiple preferred servers are selected according to the first subscriber account, the present invention prompts the first subscriber account to select the multiple preferred servers from the plurality of depository servers. Once the multiple preferred servers are selected by the first subscriber account, the present invention forwards the electronic voucher into the multiple preferred servers. When the multiple preferred servers are selected according to the dispatch center requests, the present invention prompts at least one dispatch center to select the multiple preferred servers. Once the multiple preferred servers are selected by the at least one dispatch center, the present invention forwards the electronic voucher into the multiple preferred servers. For example, the at least one dispatch center can decide the multiple preferred servers so that the electronic voucher can be stored. When the multiple preferred servers are selected according to the record of facts, the present invention selects a specific fact from the record of facts where the specific fact can be the document location, the document time, the document date, the document format, the created electronic device, the subject matter, the document status, the document content, and the subscriber information. Then the multiple preferred servers are selected according to the specific fact. Each of the multiple preferred servers shares other electronic factual copies with similar fact. Once the multiple preferred servers are selected according to the specific fact of the record of facts, the present invention forwards the electronic voucher into the multiple preferred servers.

When the electronic voucher is forwarded to the multiple preferred servers, the electronic voucher is stored within the multiple preferred servers for a predetermined time period by the present invention. The predetermined time period is individually assigned to the electronic voucher and is completed by the first subscriber account. The predetermined time period determines how long the electronic voucher is stored within the multiple preferred servers. After the predetermined time period is expired, the electronic voucher is deleted from the multiple preferred servers.

The plurality of depository servers functions independently from each others, in such way, that the multiple preferred servers, where the electronic voucher is stored, does not possess any information regarding the electronic voucher so that each of the plurality of depository servers stays anonymous from each other. This eliminates any criminal collusion between each of the plurality of depository servers and the multiple preferred servers. In addition, at the request of the first subscriber account, personally protected electronic documents may be transferred or not transferred to the multiple preferred servers as the electronic voucher while maintaining complete confidentiality.

When the electronic voucher is forwarded to the multiple preferred servers, a unique registration number is generated and, the unique registration number is attached to the voucher for purposes of further authentication.

When the second subscriber, wishes to check the authenticity of a copy of the original electronic document through the present invention, it can be done using the unique registration number. The second subscriber of the present invention does not need to create an account in order to check the authenticity of the copy of the original electronic document. In order to check the authenticity of the copy of the original electronic document, the second subscriber needs submit a second subscriber request with the unique registration number and the copy of the original electronic document to the present invention through a second subscriber interface where the second subscriber interface is a graphical user interface. The submitted copy of the original electronic document may or may not be an exact copy of the original electronic document, and at this stage of the present invention, the application software is unable to distinguish the difference. For example, the copy of the original electronic document submitted by the second subscriber can be the exact copy as the original electronic document or can be altered by the first subscriber account or someone else, where the alteration may not be noticeable to the second subscriber. Even though the copy of the original electronic document is the exact copy of the original electronic document, the application software in the present invention recognizes the copy of the original electronic document as a separate entry. Once the present invention receives the copy of the original electronic document, the present invention generates control codes for the copy of the original electronic document. The control codes use cryptographic hash function algorithms, such as, but not limited to, MD5, SHA-1, RIPEMD-160, SHA-3, so that the second electronic document can't be accidently or intentionally altered by anyone during the submission process.

In reference to FIG. 4, the present invention forwards the copy of the original electronic document and the control codes to the plurality of depository servers so that the electronic voucher can be located in order to authenticate the control codes. The present invention then locates the electronic voucher from the multiple preferred servers, and retrieves the protective codes from the electronic voucher. Then the protective codes and the control codes are compared through the multiple preferred servers in order to detect any discrepancy. The application software compares the protective codes of the original electronic document with the control codes of the copy of the original electronic document, where the control codes detect any illegitimate modifications in the copy of the original electronic document. After the comparison between the protective codes and the control codes, the present invention determines the accuracy of the copy of the original electronic document with reference to the original electronic document.

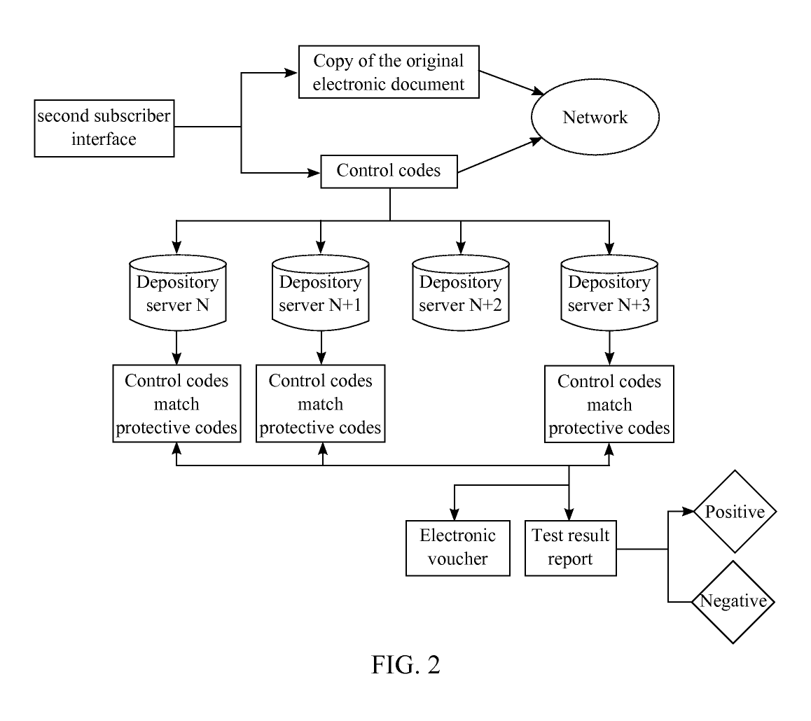

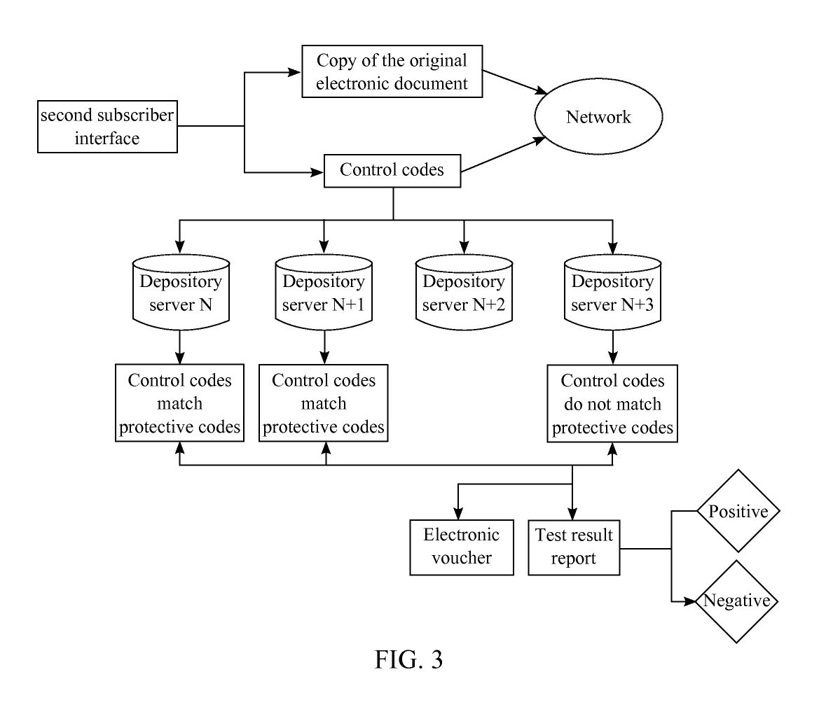

The present invention displays the accuracy of the copy of the original electronic document with reference to the original electronic document through a test result report. The test result report comprises a positive test result report or a negative test result report. In reference to FIG. 2, if the control codes match exactly with the protective codes, the positive test result report is displayed to the second subscriber through the second subscriber interface, confirming the accuracy of the copy of the original electronic document with the original electronic document. In reference to FIG. 3, if the control codes do not match with the protective codes, the negative test result report is displayed to the second subscriber through the second subscriber interface, confirming the inaccuracy of the copy of the original electronic document with respect to the original electronic document. Since the present invention uses only one cryptographic hash function algorithm, collision between the protective codes and the control codes are completely eliminated for identical electronic documents.

The at least one dispatch center can be regarded as service entity that makes it convenient for the first subscriber account and the second subscriber to interact with the plurality of depository servers. The at least one dispatch center additionally helps to register the first subscriber account of the present invention, transfer voucher between the dispatch centers, collect subscription fees, pay server fees, and many other customer services. The at least one dispatch center also helps the first subscriber account to forward the electronic voucher so that the electronic voucher can be stored within the multiple preferred servers. The at least one dispatch center can also present the electronic voucher to the second subscriber through the second subscriber interface when the electronic voucher is requested. In the present invention, the first subscriber account may be given the choice in between working directly with the plurality of depository servers or through the at least one dispatch center.

The present invention has other applications, which are large in scope, and are not limited to the following. The present invention may be used within closed communities created for many social or industrial purposes, in which the depositories may not be independent, but working collectively, and ensure the factual significance within the rules of the community.

Similarly, the applications of the present invention extend to other present and existing systems. Users of the present invention can be private or corporate users, who create any type of an electronic document or technical devices that generate important electronic information, e.g., closed-circuit television systems, telemetry, production facility management, etc. Furthermore, the present invention may be used to verify the copyright of texts, drawings, photographs, pictures and videos, to organize a legally significant document flow in between individuals, businesses and government agencies, to organize financial transactions, or to log the operation of technical devices, electronic communications systems. It is also reasonably conceivable that a verification payment system could be constructed using a method that is similar to the present invention.

Although the invention has been explained in relation to its preferred embodiment, it is to be understood that many other possible modifications and variations can be made without departing from the spirit and scope of the invention as hereinafter claimed.

What is claimed is:

1. A method of verifying the factual significance of electronic documents through a non-transitory computer-readable medium by executing computer-executable instruction comprises the steps of:
providing a plurality of depository servers;
receiving an original electronic document through a first subscriber account, wherein the original electronic document is sent through an electronic communication system;
generating an electronic voucher from the original electronic document, wherein the electronic voucher comprises a record of facts selected from the group consisting of a document location, a document time, a document date, a document format, a created electronic device, a subject matter, a document status, document content, and subscriber information;
generating protective codes for the original electronic document, wherein the protective codes validate authenticity of the original electronic document;
generating a unique registration number and attaching the unique registration number to the voucher;
adding the protective codes to the electronic voucher;
selecting multiple preferred servers from the plurality of depository servers by executing a server selection process;
forwarding the electronic voucher to the multiple preferred servers;
securely storing the electronic voucher within the multiple preferred servers;
receiving a second subscriber request in order to compare a copy of the original electronic document with the original electronic document, wherein the copy of the original electronic document may or may not be an exact copy of the original electronic document;
retrieving the copy of the original electronic document and the unique registration number with the second subscriber request through a second subscriber interface;
generating control codes from the copy of the original electronic document, wherein the control codes detect any illegitimate modifications to the copy of the original electronic document;
confirming accuracy of the copy of the original electronic document with reference to the original electronic document by comparing the control codes with the protective codes through the multiple preferred servers; and
displaying a test result report for the second subscriber interface, wherein the test result report includes the accuracy of the copy of the original electronic document with reference to the original electronic document.

2. The method of verifying the factual significance of electronic documents through a non-transitory computer-readable medium by executing computer-executable instruction, the method as claimed in claim 1 further comprises the steps of, randomly selecting the multiple preferred servers from the plurality of depository servers;
forwarding the electronic voucher into the multiple preferred servers;
prompting the first subscriber account to set a predetermined time period for the electronic voucher;
securely storing the electronic voucher for the predetermined time period; and
deleting the electronic voucher from each of the multiple preferred servers after the predetermined time period.

3. The method of verifying the factual significance of electronic documents through a non-transitory computer-readable medium by executing computer-executable instruction, the method as claimed in claim 1 further comprises the steps of,
prompting the first subscriber account to select the multiple preferred servers from the plurality of depository servers;
forwarding the electronic voucher into the multiple preferred servers;
prompting the first subscriber account to set a predetermined time period for the electronic voucher;
securely storing the electronic voucher for the predetermined time period; and
deleting the electronic voucher from the multiple preferred servers after the predetermined time period.

4. The method of verifying the factual significance of electronic documents through a non-transitory computer-readable medium by executing computer-executable instruction, the method as claimed in claim 1 further comprises the steps of,
selecting the multiple preferred servers from the plurality of depository servers according to dispatch center requests, wherein the dispatch center requests are received from at least one dispatch center;
forwarding the electronic voucher into the multiple preferred servers;
prompting the first subscriber account to set a predetermined time period for the electronic voucher;
securely storing the electronic voucher for the predetermined time period; and
deleting the electronic voucher from the multiple preferred servers after the predetermined time period.

5. The method of verifying the factual significance of electronic documents through a non-transitory computer-readable medium by executing computer-executable instruction, the method as claimed in claim 1 further comprises the steps of, selecting a specific fact from the record of facts in order to select the multiple preferred servers;
selecting the multiple preferred servers from the plurality of depository servers according to the specific fact, wherein other electronic factual copies within the multiple preferred servers share the specific fact with the electronic voucher;
forwarding the electronic voucher into the multiple preferred servers;
prompting the first subscriber account to set a predetermined time period for the electronic voucher;
securely storing the electronic voucher for the predetermined time period; and
deleting the electronic voucher from the multiple preferred servers after the predetermined time period.

6. The method of verifying the factual significance of electronic documents through a non-transitory computer-readable medium by executing computer-executable instruction, the method as claimed in claim 1 further comprises the steps of, retrieving the electronic voucher from the multiple preferred servers;
retrieving the protective codes from the electronic voucher; and
comparing the protective codes with the control codes.

7. The method of verifying the factual significance of electronic documents through a non-transitory computer-readable medium by executing computer-executable instruction, the method as claimed in claim 1 further comprises the steps of,
generating the test result report, wherein the test result report comprises a positive result report or a negative result report;
displaying the positive result report for the copy of the original electronic document through the second subscriber interface,
if the control codes match exactly with the protective codes; and
displaying the negative result report for the copy of the original electronic document through the second subscriber interface,
if the control codes do not match with the protective codes.
